(19) United States
(12) Patent Application Publication
(10) Pub. No.: US 2007/0084256 A1
(43) Pub. Date: Apr. 19, 2007

(54) Strap lock with both functions of combination code setting and key operation

(75) Inventor: Chien Hung Wu, Taipei County (TW)

Correspondence Address: BIRCH STEWART KOLASCH & BIRCH, PO BOX 747, FALLS CHURCH, VA, 22040-0747, US

(73) Assignee: SINOX CO., LTD.

(21) Appl. No.: 11/546,443

(22) Filed: Oct. 12, 2006

(30) Foreign Application Priority Data
Oct. 14, 2005 (TW) 094135861

(51) Int. Cl. E05B 73/00

(52) U.S. Cl. 70/58

(57) ABSTRACT

The present invention is in related to a strap lock with both functions of combination code setting and key operation and comprises a lock body being unlocked or locked and a buckle being hasped or separated from the lock body while the lock body being unlocked, the buckle and the lock body are connected each other via a binder so as to that a baggage being bound and buckled; the lock body has a combination locking mechanism and a key device simultaneously, thus the officer for security checking can use a special key to unlock the lock body via the key device, and the lock body can be unlocked without damaging. Besides, the lock body further has an indicator, which can be shifted to a different position after the lock body is unlocked by the key. Thus, the owner of the baggage know whether the baggage being opened or not by means of the displaying position of the indicator.

### FIELD OF THE INVENTION

The present invention is in related to a strap lock, which is applied to bind and luck a baggage or backpack for assuring the safety during delivery or traveling, especially to the strap lock being operated by both setting a combination code and a key operation; specifically, the strap lock further has an indicator with the features of resetting and visual ability. The indicator is driven simultaneously while the strap lock is operated by the key, and the indicator is able to return to an original position thereof only when the strap lock is unlocked by way of setting a combination code.

### BACKGROUND OF THE INVENTION

There is a locking tool to bind a baggage to avoid the baggage being unlocked randomly, which is called strap lock.

The strap lock with the function of setting combination code or key operation is existing already, but the strap lock can not be unlocked if the combination code is forgotten or the key is lost.

On the other hand, every country has being focused on the safety of the airport. For example, since TSA (Transportation Security Administration) in USA has managed the security checking for airports, security persons may check any dubious baggage for safety; but the lock for the dubious locked luggage are always damaged due to the combination codes or the keys are not told to the security persons.

The damaged locks for the owners are losses, and the luggage with the damaged locks is short of protection for the rest of delivery or traveling. Therefore the goods inside the luggage are risky to be stolen.

For the issue of damaging the locks of the luggage, TSA has decided to provide override keys from the Department of Travel Sentry. The override keys let the officers in the department of security directly and easily unlock and check the luggage but not breaking the locks of the luggage. The override key is not provided to general customers or travelers.

For the issue of the override key, the lock producers have to offer the lock tools with the functions of both locking and unlocking general luggage and locked and unlocked by special keys.

For the present products, the lock tool with the functions of combination code setting and key operation and another lock tool operated by two different keys are the needs at the present time.

While the special lock tools are applied to the luggage, the special lock tools can be re-locked after the checking is finished, and the luggage are still protected after checking.

For the strap lock, the products with the functions of combination code setting and key operation do exist but just a few. Thus the options for such lock tools are not satisfied to consumers.

Else, even if the lock tool having an indicator is not innovative, but the prior art of the strap lock does not have such indicator, or any technology teaches such information.

### SUMMARY OF THE INVENTION

According to the description mentioned in “Background of the Invention”, the present invention provides a strap lock with both functions of combination code setting and key operation. While the strap lock binding a baggage and the baggage is checked for security, the officer may unlock the strap lock via an override key. Consequently, the strap lock can be re-locked after checking the baggage, the strap lock can not be damaged as well.

Further more, the strap lock cooperates with the indicator with the feature of reset. The indicator may appear the situation what the strap lock is unlocked by a key, so the owner is notified by the two conditions of the strap lock being unlocked for safety checking or someone attempting to unlock the strap lock.

To approach above objectives, the preferred embodiment is to provide both a combination locking mechanism and a key device for the strap lock, as a result, any of the combination locking mechanism and the key device is operated to make the strap lock be locked or unlocked.

The strap lock comprises a lock body being opened and closed, the lock body has a button, which buckles the lock body while the lock body is closed, and the button is pressed to release the lock body. The combination locking mechanism combines with the button, and whether the button being moved or not may depend on a combination code. The key device is installed on the lock body, and even though the button is restricted to move by the combination locking mechanism to buckle the lock body, the key device still release the lock body.

Besides, the lock body further has an indicator, the indicator can be seen via a window via a case of the lock body and placed on a first position normally, and the indicator is previously locked by a combination code and may then be shifted to a second position after unlocking the lock body by means of a key. While the strap lock being applied to a baggage and once the strap lock being unlocked for security checking, the indicator is shifted from the first position to the second position, the owner of the baggage knows the baggage is opened. To return the indicator to the first position, the only way is to unlock the lock body by a combination code and stir by hand.

When the lock body is unlocked by the key, the indicator is shifted to the second position; but if the lock body is re-locked by the key, the indicator keeps stopping on the second position. To return the indicator to the first position, the only way is by handy stirring.

Wherein a plurality of displaying surface areas of the indicator may apply different colors or icons for different visualizations while the indicator is in different positions.

### BRIEF DESCRIPTION OF THE DRAWINGS

FIG. 1 is a perspective sketch of a strap lock with both functions of combination code setting and key operation of the present invention, a lock body of the strap lock is locked, and a key can be inserted into the lock body;

FIG. 2 is a perspective sketch of a buckle off the lock body of the present invention, the strap lock is locked;

FIG. 3 is a top view of the strap lock without a binder of the present invention;

FIG. 4 is a sketch of an A-A profile of the lock body of FIG. 3 of the present invention, a dot line presents a partial binder;

FIG. 5 is a sketch of variable shifted positions of a force-applied button moving into an internal of the lock body of FIG. 4 of the present invention, a dot line presents the state of the lock body being opened;

FIG. 6 is an exploded sketch of the lock body of the strap lock of the present invention;

FIG. 7 is an exploded sketch of the lock body of the strap lock of the present invention from a different direction;

FIG. 8 is a perspective sketch of ignoring some components of the lock body of the present invention, the lock body is unlocked;

FIG. 9A is a partial perspective sketch of the present invention, which presents a combination locking mechanism and a cooperated combination code reset device;

FIG. 9B is a top perspective view of the components of FIG. 9A;

FIG. 10A is a top view of the partial present invention, which presents the situation of the combination locking mechanism and the combination code reset device being stirred and pushed;

FIG. 10B is a front perspective view of FIG. 10A;

FIG. 11 is a front view of the lock body being opened vertically of the strap lock of the present invention while ignoring some components;

FIG. 12 is a sketch of variable situations of the force-applied button moving into the internal of the lock body of the present invention, while a combination code in the combination locking mechanism being correct of FIG. 11;

FIG. 13 is a sketch of variable situations of the key operating a key device and the force-applied button moving into the internal of the lock body of the present invention, while a combination code in the combination locking mechanism being incorrect of FIG. 11;

FIG. 14 is a sketch of variable situations of the key device being reset, while the force-applied button of FIG. 13 is released;

FIG. 15A is a perspective sketch of the partial present invention;

FIG. 15B is a top view of FIG. 15A;

FIG. 16A is a perspective sketch of the partial present invention, which presents the variable situations of an indicator being driven by the key device; and

FIG. 16B is a top view of FIG. 16A.

### DETAILED DESCRIPTION OF THE PREFERRED EMBODIMENTS

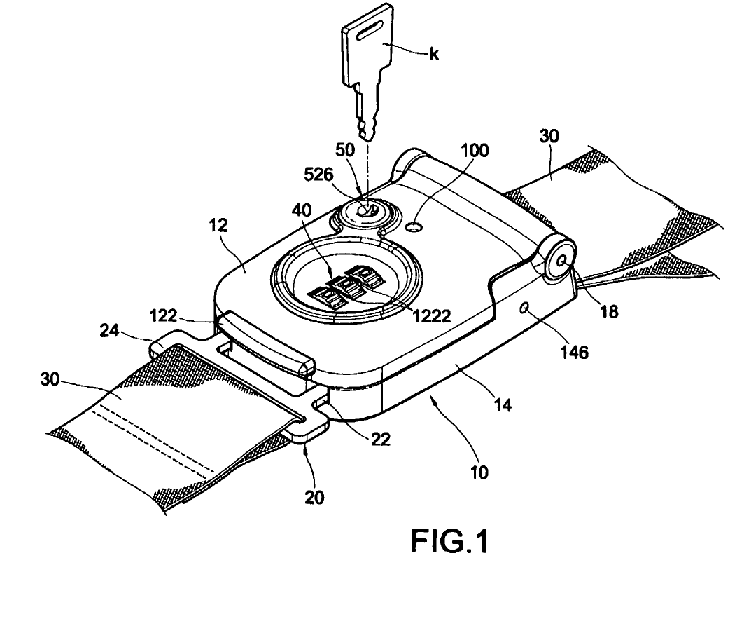

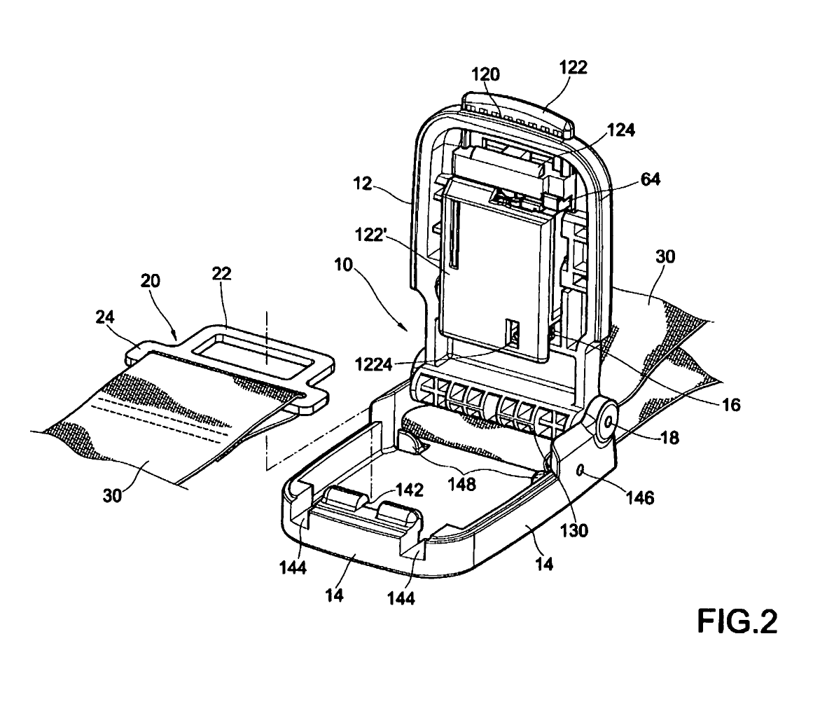

Please refer to FIG. 1 and FIG. 2, which illustrate a strap lock with both functions of combination code setting and key operation. The strap lock comprises a lock body 10 can be unlocked and locked and a buckle 20 has a first end and a second end. The first end hasps or separates from the lock body 10 while the lock body 10 is unlocked, the second end connects the lock body 10 by means of a binder 30, thus a closing ring is formed while the condition of the first end hasping and the second end connecting the lock body 10 is happened, and the strap lock can be bond with a package while traveling.

The lock body 10 has two devices for locking and unlocking. One is a combination locking mechanism 40 locked and unlocked by combination code, another is a key device 50 locked and unlocked by inserting and rotating a key K. After unlocking the lock body 10 by means of the combination locking mechanism 40 or the key device 50, a button 122 can be pressed and then drawn back to the internal of the lock body 10 so as to that lifting up a part of the lock body 10, continuously the buckle 20 is then separated from or reconnected to the lock body 10.

Besides, there is an indicator in the lock body 10 and a window 100 on the case of the lock body 10 for viewing the indicator.

A relationship among the lock body 10, the buckle 20 and the binder 30 will be described in detail as following: each of two sides of a front end of a bottom cover 14 has designed a fillister 144. The buckle 20 straddles on or takes off the fillisters 144 while a top cover 12 and the bottom cover 14 are unlocked.

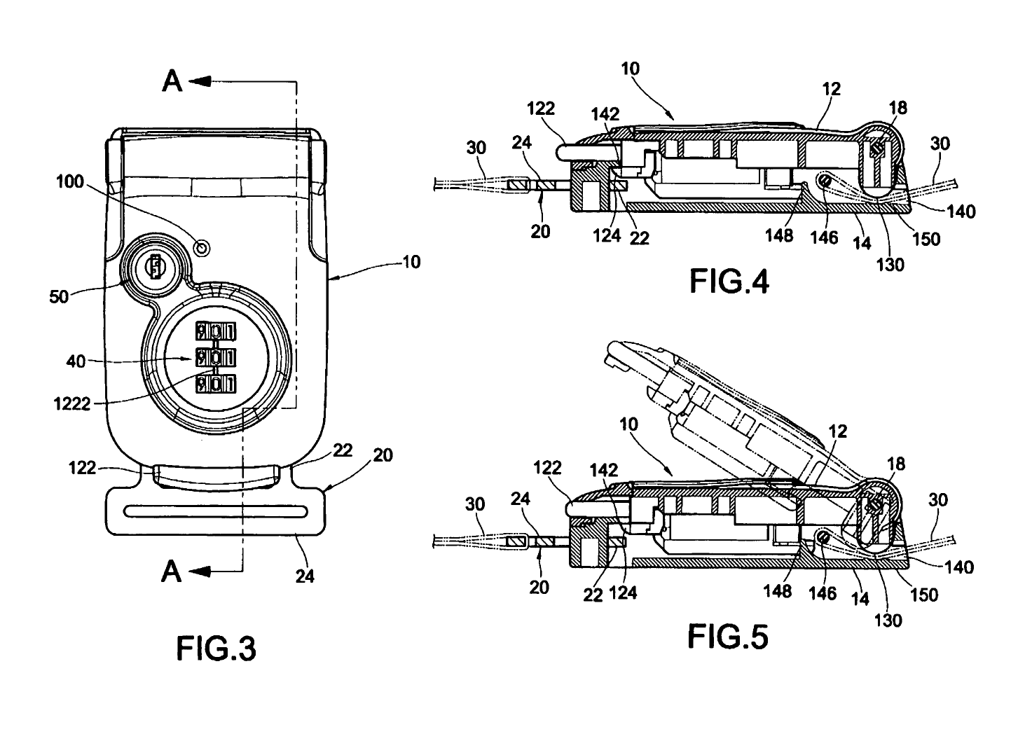

Please refer to FIG. 3, FIG. 4 and FIG. 5 simultaneously, a first ring portion 22 of the buckle 20 straddles on the fillisters 144, a second ring portion 24 of the buckle 20 connects the binder 30. A rear end of the bottom cover 14 has an open trough 140 for the binder 30 going into the lock body 10, and a traverse rod 146 through the internal of the bottom cover 14 can be surrounded by the binder 30, continuously the binder 30 is pull out from the open trough 140. On the other hand, a ridge 148 is located on the internal surface of the bottom cover 14 and below the traverse rod 148 for a limit of the binder 30 going into the lock body 10. More than one traverse rib 150 are set on the location closer to the internal surface of the rear end of the bottom cover 14. A non-smooth batten 130 is located on the rear edge of the rear end of the top cover 12. Therefore, the traverse ribs 150 and the batten 130 function to clamp the binder 30 while the top cover 12 and the bottom cover 14 cover each other.

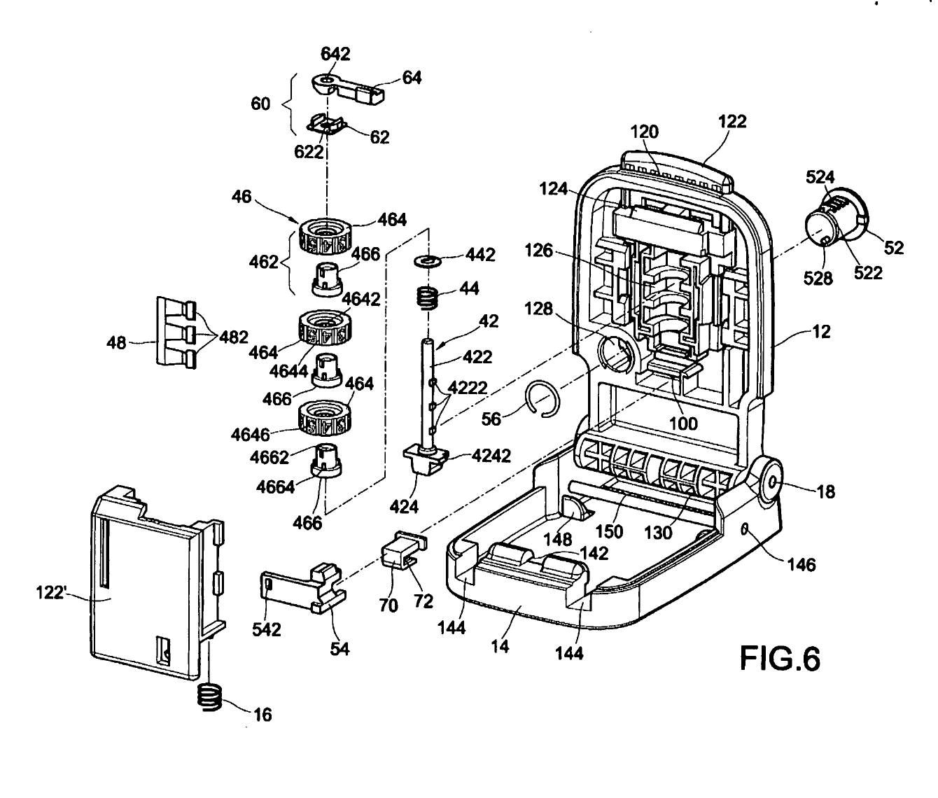

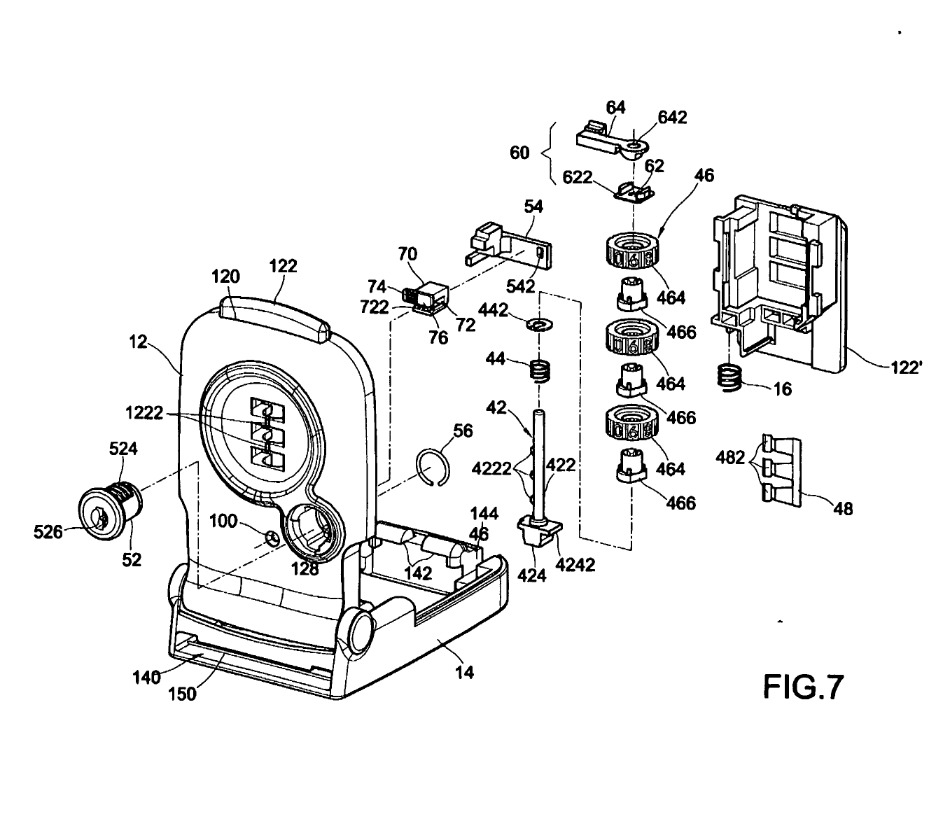

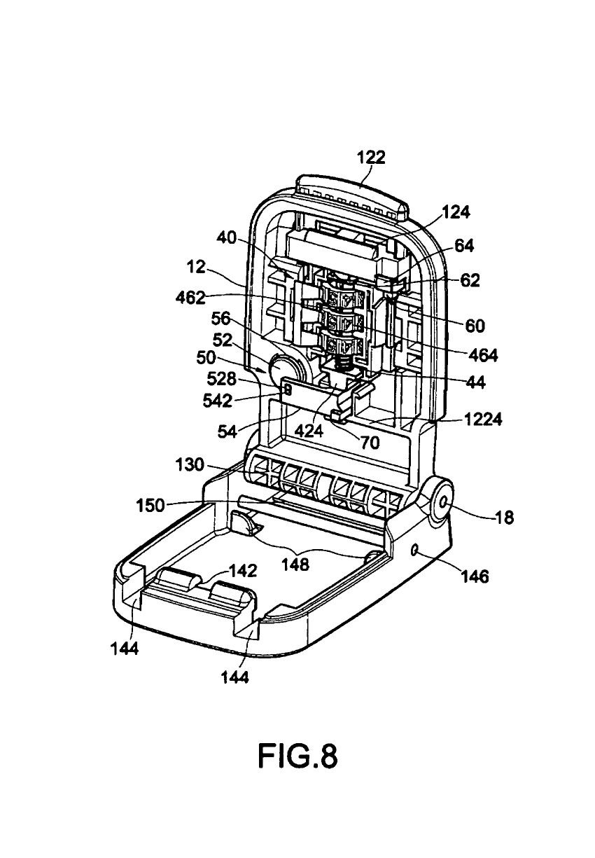

Please refer to FIG. 6 and FIG. 7, which illustrate two perspective exploded sketches of the lock body 10 in different angles. FIG. 8 illustrates the state of the unlocked lock body 10 but ignoring some components. The lock body 10 has the top cover 12 and the bottom cover 14, the top cover 12 and the bottom cover 14 connect each other by a pivotal axis 18, thus the two covers can be separated by lifting or covered together. The top cover 12 defines a sliding guide 120 for containing and moving the button 122 linearly. Further, an open is designed in the front end of the top cover 12 and to contain and keep the button 122 a period elongated outside of the top cover 12, the period is then a force-applied portion.

The button 122 has a first detaining portion 124, and the bottom cover 14 has a second detaining portion 142. The first detaining portion 124 and the second detaining portion 142 are cooperated for buckling each other while the top cover 12 is affixed to the bottom cover 14. The button 122 is an active member assembled on the top cover 12, and the top cover 12 has a containing slot 126 for the combination locking mechanism 40. The button 122 further includes an assembling hood 122′ to wrap and position to avoid movement and deconstruction of the assembled members.

The combination locking mechanism 40 has an axis rod 42, a flexible member 44, a combination wheel set 46 assembled by a plurality of combination code wheels and a sensing piece; wherein the axis rod 42 has a rod body 422 and a head 424 located on an end edge of the rod body 422, an outward extension of the head 424 is a shoulder 4242 so as to the axis rod 42 being fixed in the containing slot 126 of the button 122 by means of the shoulder 4242.

The flexible member 44 and the combination wheel set 46 are inserted into the rod body 422 of the axis rod 42 simultaneously, further that, the flexible member 44 is in between the head 424 and the combination wheel set 46, the flexible member 44 against the head 424 may withstand the axis rod 42. After the flexible member 44 and the combination wheel set 46 are surrounded the axis rod 42 according to aforesaid, the head 424 of the axis rod 42 and each combination code wheel 462 of the combination wheel set 46 may then be positioned into a relative channel of the containing slot 126 of the button 122, therefore the combined member carried by the button 122 follows the movement of the button 122. To install the combination wheel set 46 on the button 122 lets the plurality of combination code wheels 462 penetrate out of the button 122, therefore the combination code wheels 462 are exposed to the surface of the top cover 12 for axial stirring.

The combination code wheel 462 is a combined member by means of an external ring wheel 464 and an internal bushing 466, a center of the external ring wheel 464 is a joining hole 4642, the internal bushing 466 has a plurality of joining teeth 4664 to cooperate with the joining hole 4642. It is to combine the internal bushing 466 and the external ring wheel 464 by way of joining. Additionally, an axial hole 4662 of the internal bushing 466 is able to surround the axis body 422 of the axis rod 42.

A plurality of tooth portions 4222 protrude out of a surface of the axis body 422 of the axis rod 42. The axial hole 4662 of the internal bushing 466 is designed a gap comparatively, therefore each internal bushing 466 of the combination code wheel 462 is stirred to a position where the gap and the tooth portion 4222 being comparative, the internal bushing 466 is axially moved toward the direction of pressing the flexible member 44. The internal bushing 466 may be taken off the external ring wheel 464. Under the condition, the external ring wheel 464 can be stirred to re-joint the internal bushing 466.

Besides, an external surface of the external ring wheel 464 is averagely separated a plurality of surface fillisters 4644, a surface numeral 4646 or symbol is in between any two surface fillisters 4644. However, according to aforesaid, each combination code wheel 462 includes the external ring wheel 464 and the internal bushing 466, and the external ring wheel 464 and the internal bushing 466 can be joined each other in different directions and angles. While the installment of the combination code wheel 462 and the button 122 is finished, all of the internal bushings 466 of the combination code wheels 462 are against each other. By way of rejoining the external ring wheels 464 and the internal bushings 466, the surface numeral 4646 of the external ring wheel 464 comparative to a plurality of surface points 1222 of the button 122 can be predetermined before installing each combination code wheel 462. For example, the numeral of 0-0-0 is a combination code to allow the combination code wheel set 46 moving relatively to the axis rod 42.

The sensing piece 48 is made of elastic material, and can be assembled with the assembling hood 122′; further that, the sensing piece 48 has a plurality of flexible arms 482 to produce stirring friction force to each of the combination code wheels 462 for positioning.

To assure the flexible member 44 being against the combination wheel set 46 tightly and avoiding the flexible member 44 being not against the combination wheel set 46 efficiently due to the larger, smaller or slant flexible member 44, a spacer 442 is added between the two joint surfaces of the flexible member 44 and the combination wheel set 46. The spacer 442 is defined to transmit the elastic force from the flexible member 44 to the combination wheel set 46.

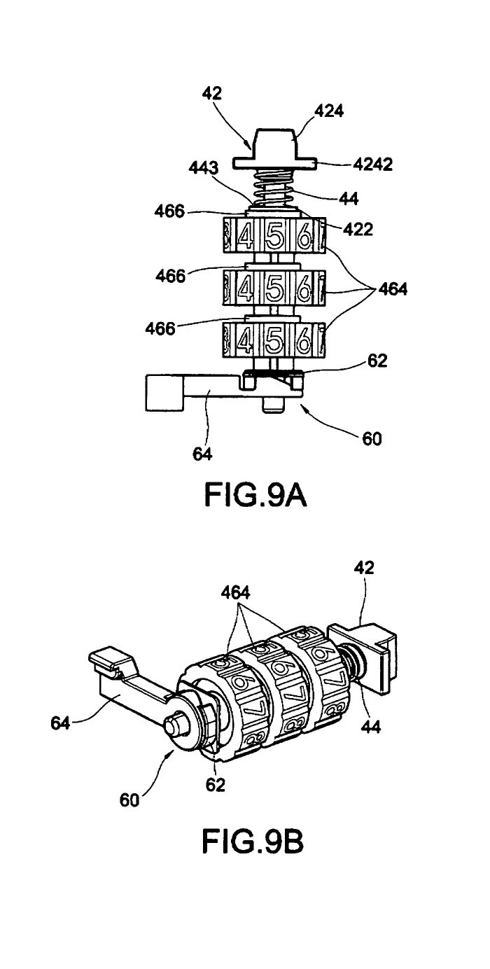

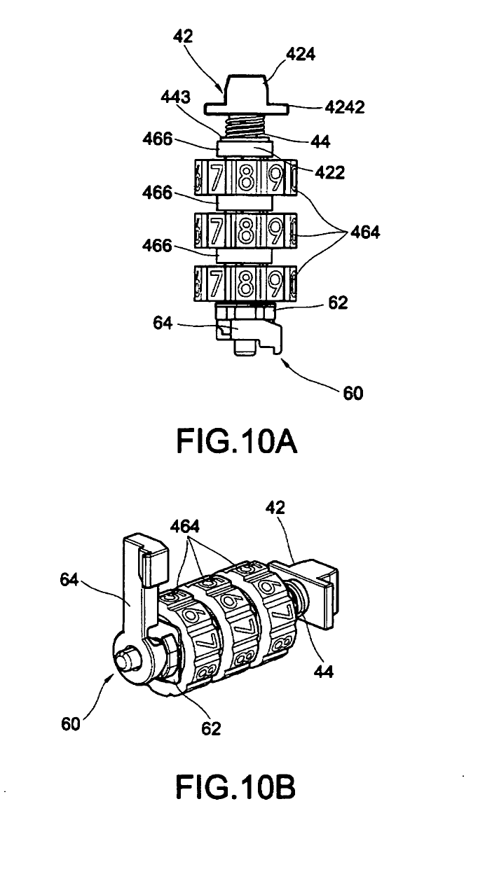

Please refer to FIG. 9A and FIG. 9B, the button 122 further has a combination code reset device 60 comprising a stirring block 62 and a stirring rod 64. The stirring block 62 and a stirring rod 64 has an axial hole 622 and another axial hole 642 individually for penetrating through the rod body 422 of the axis rod 42 and being against a side of the combination wheel set 46 relative to the flexible member 44, thus the assembly of the stirring block 62 and a stirring rod 64 together with the axis rod 42 is installed on the button 122. Continuously, the combination of the assembly and the button 122 is constructed on the combination locking mechanism 40. Please refer to FIG. 10A and FIG. 10B, the stirring rod 64 is rotated to push the stirring block 62 for moving linearly while all of the combination code wheels 462 are stirred to the predetermined combination code positions. Thus all of the internal bushings 466 and the external ring wheels 464 are pushed to positions for releasing; after the external ring wheels 464 move to different joining positions comparative to the internal bushings 466, the stirring rod 64 stops pushing the stirring block 62, and the internal bushings 466 automatically go back to the positions where the internal bushings 466 joining to the internal ring wheels 464. It makes the combination code be changed from now on.

While the combination locking mechanism 40 and the combination code reset device 60 are installed together on the button 122, the assembling hood 122′ lodged in the button 122 provides the functions of positioning and protection to avoid loosing members.

Except the combination locking mechanism 40, the lock body 10 has the key device 50 locked and unlocked by inserting and rotating a key K as well. The key device 50 has a reacting member 52 and a braking member 54. The reacting member 52 is fit together with an assembling hole 128 of the top cover 12, then a buckling bolt 56 buckles up a ring slot 522 of the reacting member 52 so as to that the reacting member 52 combining with the top cover 12 by way of rotation. A plurality of thin pieces 524 are designed on the surface of the reacting member 52, and the thin pieces 524 are lodged into lodging slots 1282 in the assembling hole 128. That is, a proper key K is inserted into a key hole 526 on the surface of the top cover 12, and then all of the thin pieces 524 are drawn back to the reacting member 52, continuously the thin pieces 524 can be rotated by the key K.

The braking member 54 has an embedding slot 542 and a long hole 544, the long hole 544 wraps around and connects a slanted axis of an end surface of the reacting member 52. Thus the braking member 54 is driven simultaneously when the reacting member 52 is moved by inserting and rotating the key K.

Please be noted, while the key device 50 is installed on the top cover 12 according to aforesaid, the braking member 54 is just against a head 424 of the axis rod 42, and thus an axial front end of the axis rod 42 is blocked.

After the combination locking mechanism 40, the combination code reset device 60 and the key device 50 are assembled together on the lock body 10 and the assembling hood 122′ hooks up the button 122, a flexible member 16 can be put in the top cover 12 as well. An end of the flexible member 16 is against an internal of the top cover 12, another end wraps around to be against the button 122 or the assembling hood 122′. Therefore the button 122 is always kept to buckle up the bottom cover 14 by means of the flexible member 16.

According to the figures, the lock body 10 further has an indicator 70, and a window 100 is located on the top cover 12 of the lock body 10, thus the indicator 70 can be seen from outside of the lock body 10 through the window 100. Wherein the indicator 70 has a clamping trough straddling on the guiding rail 1224, and a lodging block 1226 and a lodging slot 722 for positioning installed on a joint surface comparatively to lodge the indicator 70 onto the guiding rail 1224.

Along with aforesaid, the present invention discloses the lock body 10 simultaneously comprising the combination locking mechanism 40, the key device 50, the combination code reset device 60 and the indicator 70 shown by the window 100; besides, the lock body 10 connects the buckle 30 via the binder 20, the buckle 30 hasps or separates from the lock body 10 while the lock body 10 is unlocked.

There are two types of operations for the lock body 10, one is to set up a combination code by the combination locking mechanism 40, another is by means of the key K and the key device 50. Thus the button 122 always keeping the lock body 10 being under a locking state can be driven and moved to a position where the lock body 10 being unlocked.

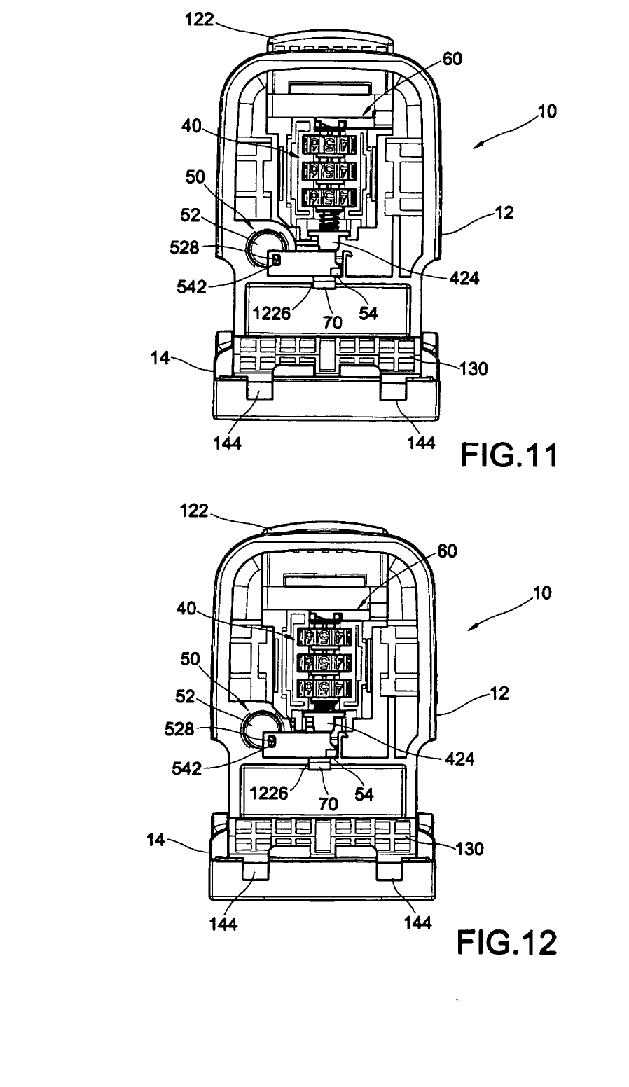

Please refer to FIG. 11, it is shown that the state of the top cover 12 of the lock body 10 being vertically opened comparative to the bottom cover 14 and the assembling hood 122′, the flexible member 16 and the sensing piece 48 being ignored. While the combination locking mechanism 40 hasping the button 122 is stirred to a correct combination code via each of the combination code wheel 462, and every gap of the internal bushing 466 is relative to the tooth portion 4222 of the axial rod 42, as shown in FIG. 12, the button 122 with the combination code wheel 462 and the combination code reset device 60 is moved toward the internal of the lock body, thus the first detaining portion 124 of the button 122 is also moved to release the second detaining portion 142 of the bottom cover 14 so as to that the lock body being unlocked.

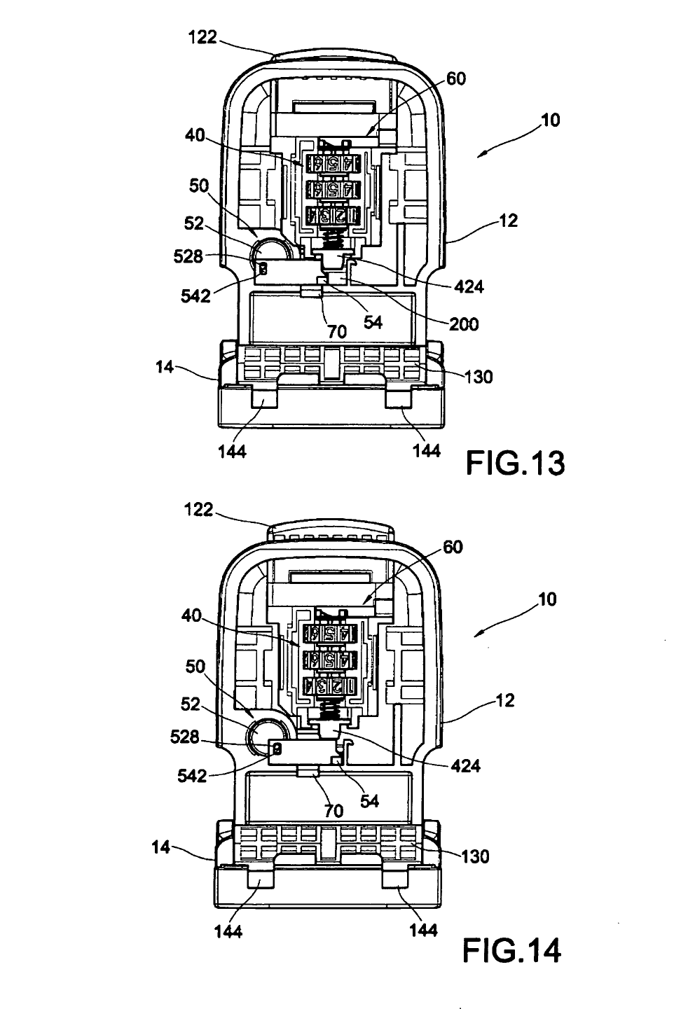

On the other hand, any one of the combination code wheels 462 of the combination locking mechanism 40 is not stirred to a correct position correspondingly, the button 122 is then not moved. Optionally the key device 50 can be operated to let the button 122 be moved for unlocking the lock body 10. As shown in FIG. 13, while the key K is inserted into the reacting member 52 via the key hole 526 of the top cover 12, and the reacting member 52 is driven to the position where the reacting member 52 is moved to, the driven braking member 54 is also moved at the same time. Therefore, the braking member 54 is then moved toward the left of FIG. 13 to have an acting room 200, the acting room 200 is reserved for the head 424 going in, thus the button 122 carrying with the whole combination locking mechanism 40, including the combination wheel set 46, and the combination code reset device 60 may be moved for lifting and unlocking the lock body 10.

As shown in FIG. 14, while the button 122 is not applied by force, the button 122 is then back to a normal position thereof by means of the flexible member 16. The key K reversely turns the reacting member 52, the braking member 54 is also back to its original position where blocking the head 424 of the axis rod 42.

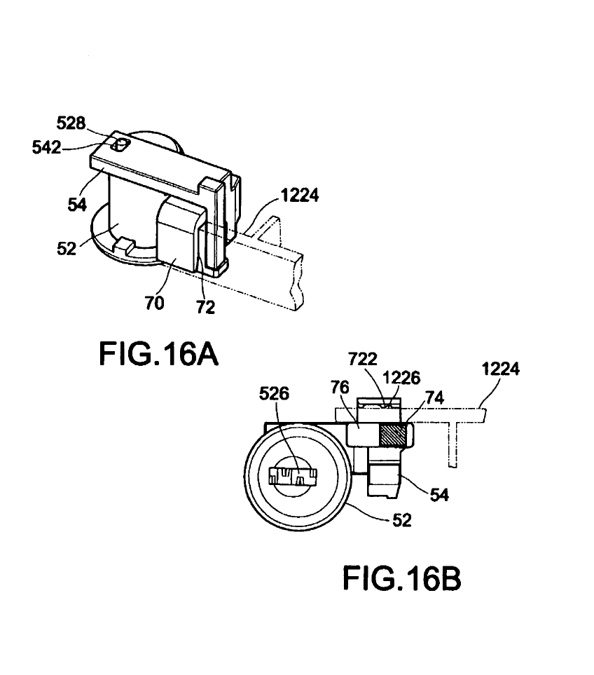

Please refer to both FIG. 13 and FIG. 14, FIG. 13 shows that the indicator 70 is placed on a first position normally, and the indicator 70 may be shifted to a second position by the braking member 54 after unlocking the lock body 10 by means of the key K and the key device 50, the second position is shown as in FIG. 16; the indicator 70 keeps stopping on the second position while the lock body 10 being locked again by means of the key K and the key device 50.

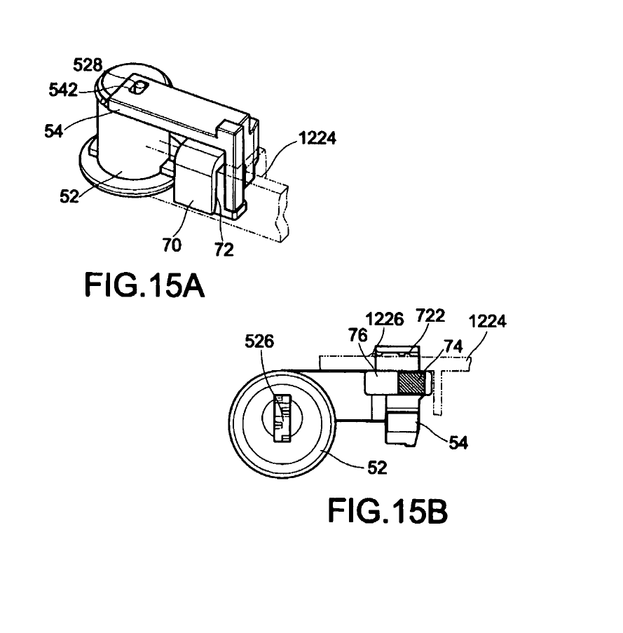

Please refer to both FIG. 15A and FIG. 15B, the figures show the connection relationship of the reacting member 52, the braking member 54, the indicator 70 and the guiding rail 1224. As shown in the figures, the lock body 10 has the window 100 for displaying the indicator 70. The indicator 70 has a first surface area 74 for displaying the first position and a second surface area 76 for displaying the second position, wherein there are two different colors for the first surface area 74 and the second surface area 76 individually. For example, the first surface area 74 is represented by green color, and the second surface area 76 is represented by red color. Besides, there are two different icons represented for the first surface area 74 and the second surface area 76 individually on the indicator as well.

While the reacting member 52 is driven by inserting and rotating the key K, the reacting member 52 is shifted to the positions shown as in FIG. 16A and FIG. 16B, the indicator 70 straddling on the guiding rail 1224 may be driven by the braking member 74. The indicator 70 is moved from the first surface area 74 relative to the window 100 to the second surface area 76 relative to the window 100.

Please be noted, the braking member 54 only drives the indicator 70 in one direction. While the key K reversely operates the key device 50 again, the indicator 70 keeps stopping on the second position.

Hence, while the present invention is applied to a baggage and the strap lock of the present invention may be unlocked by the key K for checking, the indicator 70 is shifted from the original first position to the second position. It is to let the owner of the baggage know whether the baggage being opened or not. To return the indicator 70 to the first position, the only way is to unlock the lock body 10 by a combination code and stir by hand.

As aforesaid, the strap lock provided by the present invention is assured for binding baggage. Even if the baggage is being delivered or checked, the strap lock can be unlocked by an override key; further that, it is re-locked after checking to avoid damage.

In addition, the strap lock cooperates with the indicator with the feature of reset. The indicator may appear the situation what the strap lock is unlocked by a key, so the owner is notified by the two conditions of the strap lock being unlocked for safety checking or someone attempting to unlock the strap lock.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A strap lock with both functions of combination code setting and key operation comprising:
a lock body being unlocked and locked;
a buckle having a first end and a second end, the first end hasping or separating from the lock body, the second end connecting the lock body by means of a binder;
wherein the lock body has a button and a combination locking mechanism, the button is for unlocking and locking the lock body, the combination locking mechanism is to control the button for unlocking, the lock body further has a key device to control the button for unlocking.

2. The strap lock with both functions of combination code setting and key operation according to claim 1, wherein the lock body pivotally connects a top cover and a bottom cover, the button is combined with the top cover and hooked up the bottom cover.

3. The strap lock with both functions of combination code setting and key operation according to claim 2, wherein the lock body has a flexible member against the button is to maintain that the button hooking up the bottom cover.

4. The strap lock with both functions of combination code setting and key operation according to claim 1, wherein the lock body further has an indicator placed on a first position normally, and the indicator may be shifted to a second position after unlocking the lock body by means of a key and the key device, the indicator keeps stopping on the second position while the lock body being locked again.

5. The strap lock with both functions of combination code setting and key operation according to claim 4, wherein the lock body has a window for displaying the indicator.

6. The strap lock with both functions of combination code setting and key operation according to claim 5, wherein the indicator has a first surface area for displaying the first position and a second surface area for displaying the second position.

7. (canceled)

8. (canceled)

9. A strap lock with both functions of combination code setting and key operation comprising:
a lock body being unlocked and locked and having a button optionally kept on an unlocking position for the locked lock body engaging an unlocking action and optionally kept on a locking position for the locked lock body engaging an unlocking action; a combination locking mechanism for the button being kept on the unlocking position, and a key device having a reacting member and a braking member for accepting and rotationally driving a key, the braking member optionally accepting the button and the combination locking mechanism for moving together to unlock the lock body;
a buckle having a first end and a second end, the first end hasping or separating from the lock body, the second end connecting the lock body by means of a binder.

10. The strap lock with both functions of combination code setting and key operation according to claim 9, wherein the lock body pivotally connects a top cover and a bottom cover, the button is combined with the top cover and hooked up the bottom cover.

11. The strap lock with both functions of combination code setting and key operation according to claim 10, wherein the lock body has a flexible member against the button is to maintain that the button hooking up the bottom cover.

12. The strap lock with both functions of combination code setting and key operation according to claim 9, wherein the lock body defines a sliding guide for moving the button linearly.

13. The strap lock with both functions of combination code setting and key operation according to claim 9, wherein the reacting member drives rotationally the braking member for moving linearly.

14. The strap lock with both functions of combination code setting and key operation according to claim 13, wherein the reacting member has a slanted axis to connect the braking member.

15. The strap lock with both functions of combination code setting and key operation according to claim 9, wherein the lock body further has an indicator placed on a first position normally, and the indicator may be shifted to a second position after unlocking the lock body by means of a key and the key device, the indicator keeps stopping on the second position while the lock body being locked again.

16. The strap lock with both functions of combination code setting and key operation according to claim 15, wherein the indicator is driven by the braking member and moved from the first position to the second position.

17. The strap lock with both functions of combination code setting and key operation according to claim 15, wherein the lock body has a window for displaying the indicator.

18. The strap lock with both functions of combination code setting and key operation according to claim 15, wherein the indicator has a first surface area for displaying the first position and a second surface area for displaying the second position.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A strap lock with both functions of combination code setting and key operation comprising:
a lock body being unlocked and locked and having a combination locking mechanism for unlocking the lock body via combination codes; a key device for unlocking the lock body; and an indicator placed on a first position optionally, and the indicator being shifted to a second position after unlocking the lock body by means of a key and the key device, the indicator being kept on the second position while the lock body being locked again by means of the key and the key device;
a buckle having a first end and a second end, the first end hasping or separating from the lock body while the lock body being unlocked, the second end connecting the lock body by means of a binder.

44. The strap lock with both functions of combination code setting and key operation according to claim 43, wherein the lock body has a window for displaying the indicator.

45. The strap lock with both functions of combination code setting and key operation according to claim 43, wherein the indicator has a first surface area for displaying the first position and a second surface area for displaying the second position.

46-48. (canceled)
